(19) United States
(12) Patent Application Publication
(10) Pub. No.: US 2005/0244309 A1
(43) Pub. Date: Nov. 3, 2005

(54) Air cleaner with photocatalyst materials adopted for light-gauge steel frame

(75) Inventor: Ruei-Shan Wang, Taipei (TW)

Correspondence Address: TROXELL LAW OFFICE PLLC, SUITE 1404, 5205 LEESBURG PIKE, FALLS CHURCH, VA, 22041, US

(73) Assignee: Taiwan Flourescent Lamp Co., Ltd.

(21) Appl. No.: 10/834,872

(22) Filed: Apr. 30, 2004

(51) Int. Cl. B01J 19/08

(52) U.S. Cl. 422/186.3

(57) ABSTRACT

An air cleaner with photocatalyst materials adopted for a light-gauge steel frame includes a housing, a fan device, a photocatalyst lighting device and a lampshade. Further, the housing includes a faceplate and a cover arranged behind the faceplate; the fan device includes a circular casing, a plurality of ribs disposed in the circular casing, and an air supply device disposed on the ribs; the photocatalyst lighting device includes a lamp annularly exposed out the ribs, a photocatalyst sleeve has a Titanium Dioxide (TiO2) coating and wrapping on the lamp, and a driving module electrically connecting the lamp; the lampshade is annularly arranged on an exterior peripheral of the lamp.

### BACKGROUND OF THE INVENTION

1. Field of the Invention

The present invention relates to an air cleaner adopted for a light-gauge steel frame, and particularly relates to an air cleaner adopted for a light-gauge steel frame with a photocatalyst for sterilizing.

2. Background of the Invention

A photocatalyst is one kind of catalysts, which is used for accelerating a chemical transformation without appearing in the products and without changing chemical equilibriums. When a photo with a predetermined energy matches or exceeds an energy band gap of the photocatalyst, such as Titanium Dioxide (TiO₂) particle, an oxidation-reduction reaction reacts on TiO₂ particle to excite oxygen molecules (O₂) or water molecules (H₂O) surrounding everywhere to be superoxide anion radicals (O2⁻) or hydroxyl radicals (OH⁻), which cause free-radical damage to decompose organic materials into carbon dioxide (CO²) and water (H²O) etc for cleaning up pollution in the air and water, and providing sterilization, decontamination and deodorization etc. According to a first prior art providing a waste gas disposal UV lamp adopted for a light-gauge steel frame, R.O.C. Application NO. 87113380 and U.S. Pat. No. 6,135,838, which is presented by the inventor of the present invention, a glass-fiber-cloth with a photocatalyst coating is wrapped on a UV lamp for treating waste gases through irradiating UV light therefrom on a surface thereof to generate free electron and electron hole pairs which can decompose waste gases into unharmful gases. The first prior art also provides lighting.

A second prior art provides a suspension air cleaner adopted for a light-gauge steel frame, R.O.C. Patent NO. 477240. A filter bag is disposed at a wind entrance for gathering large particles in the air, and a filter plate arranged behind the filter bag collects small particles and removes odors. However, the second prior art fails to oxidize organic materials or inorganic pollutions. A third prior art provides an ozonic air cleaner arranged on a light-gauge steel frame, a housing having an inhale window arranged on a middle thereof for breathing in airs, an air filter disposed behind the inhale window, an ozone generation device arranged behind the air filter, a cleaning device disposed behind the ozone generation device, an anion generation device disposed behind the cleaning device, and a plurality of exhausts communicating with the anion generation device and surrounding the inhale window. Wherein the airs pass through the air filter, the ozone generation device, the cleaning device, the anion generation device, and the exhausts sequently. For the airs passing fluently, the housing exposes out a suspension ceiling, and this is not pleasing to the eye; in addition, the ozone concentration has a maximum limitation ruled by International Electrotechnical Commission (IEC) for health hazards, the ozone concentration exceeds the maximum limitation is harmful to human's health. Nevertheless, if the ozone concentration is too low, the ability of sterilization cannot rise. The third prior art should further include an ozone concentration-monitoring device arranged therein for security, but it can raise costs. Besides, components of the third prior art are complicated and difficult to maintain, so that third prior art needs professional persons while wearing out.

Conventional air cleaners combined with a photocatalyst, for example, R.O.C. Patent NO. 543448, R.O.C. Patent NO. 495008, R.O.C. Patent NO. 439964, and R.O.C. Patent NO. 424877, each provides a standing air cleaner, which occupies the vacancy of the house. The standing air cleaner provides a UV lamp, a plurality of frames surrounding the UV lamp, and a plurality of photocatalyst coating plates respectively arranged on the frames. Therefore, there are lots of complicated steps during the manufacturing process, and the UV lamp in the standing air cleaner is not used for lighting.

Hence, an improvement over the prior art is required to overcome the disadvantages thereof.

### SUMMARY OF INVENTION

The primary object of the invention is therefore to specify an air cleaner providing sterilization and adopted for a light-gauge steel frame without occupying vacancy.

The secondary object of the invention is therefore to specify an air cleaner with photocatalyst materials adopted for a light-gauge steel frame

The third object of the invention is therefore to specify an air cleaner providing indoors lighting or slightly light in a darkroom.

According to the invention, this object is achieved by an air cleaner with photocatalyst materials adopted for a light-gauge steel frame, the air cleaner with photocatalyst materials adopted for a light-gauge steel frame includes a housing, a fan device, a photocatalyst lighting device and a lampshade. Wherein the housing includes a faceplate and a cover arranged behind the faceplate; the fan device includes a circular casing, a plurality of ribs disposed in the circular casing, and an air supply device disposed on the ribs; the photocatalyst lighting device includes a lamp annularly exposed out the ribs, a photocatalyst sleeve has a Titanium Dioxide (TiO2) coating and wrapping on the lamp, and a driving module electrically connecting the lamp; the lampshade is annularly arranged on an exterior peripheral of the lamp.

To provide a further understanding of the invention, the following detailed description illustrates embodiments and examples of the invention. Examples of the more important features of the invention thus have been summarized rather broadly in order that the detailed description thereof that follows may be better understood, and in order that the contributions to the art may be appreciated. There are, of course, additional features of the invention that will be described hereinafter and which will form the subject of the claims appended hereto.

### BRIEF DESCRIPTION OF THE DRAWINGS

These and other features, aspects, and advantages of the present invention will become better understood with regard to the following description, appended claims, and accompanying drawings where:

FIG. 1 is a perspective view of an air cleaner according to the present invention;

FIG. 2 is a cross-sectional profile of the air cleaner according to the present invention;

FIG. 2A is a cross-sectional profile of a photocatalyst lighting device according to another embodiment of the present invention; and

FIG. 3 is a perspective view of the air cleaner while arranging on a suspension ceiling according to the present invention.

### DETAILED DESCRIPTION OF THE EMBODIMENTS

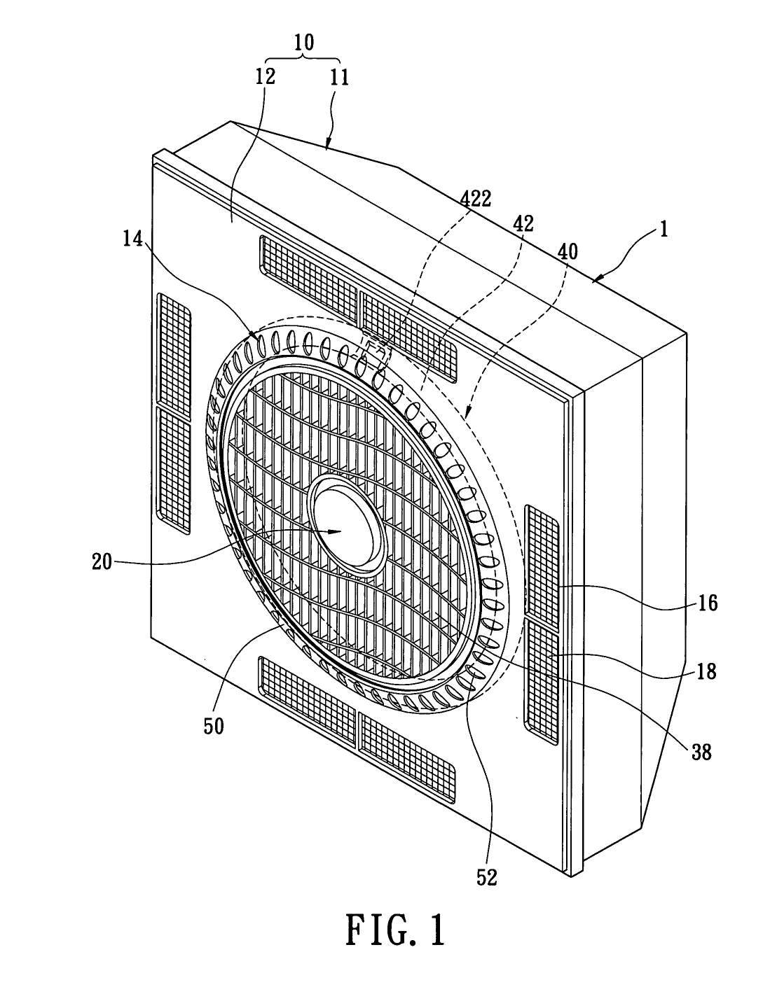

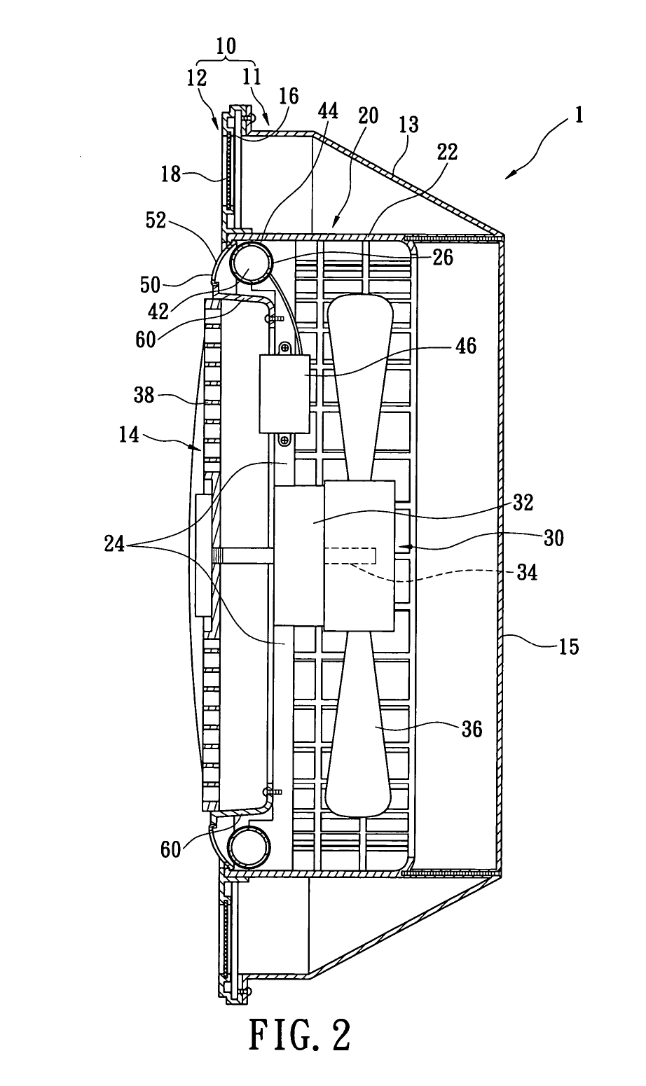

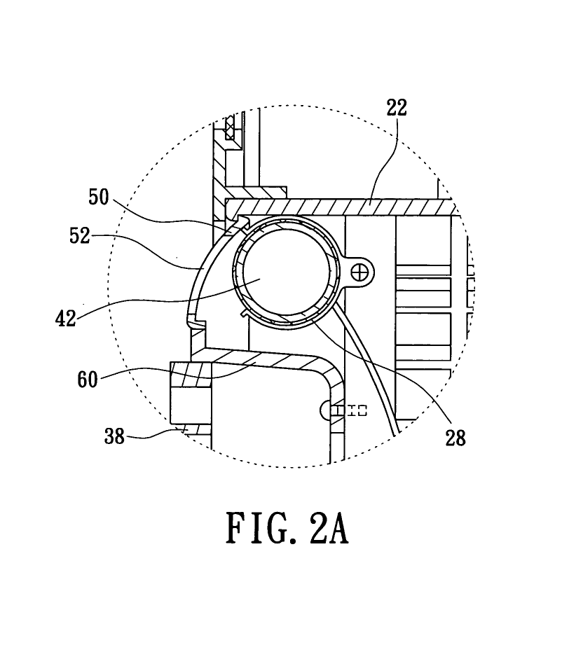

Referring to FIG. 1, the present invention provides an air cleaner 1 with photocatalyst materials adopted for a light-gauge steel frame includes a housing 10, a fan device 20 disposed in the housing 10 and a photocatalyst lighting device 40 arranged in the fan device 20. With reference to FIG. 2, the housing 10 includes a faceplate 12, which is flat, a cover 11 arranged behind the faceplate 12, and a receiving cavity formed between the faceplate 12 and the cover 11. The faceplate 12 has an exhaust 14 and a plurality of air filer frames 16 with filters 18, which are replaceable. According to the embodiment, the faceplate 12 of the present invention provides four air filer frames 16 arranged on four sides thereof. The cover 11 includes a plurality of oblique plates 13 respectively arranged on the sides thereof for guiding airs fluently and a flat bottom plate 15 separated from the circular casing 22 with a predetermined distance.

The fan device 20 includes a circular casing 22, a plurality of ribs 24 disposed in the circular casing 22, and an air supply device 30 disposed on the ribs 24. The circular casing 22 connects the exhaust 14 of the faceplate 12 for orienting the housing 10 in the receiving cavity. The air supply device 30 has a motor 32 oriented on a middle of the ribs 24, the motor 32 has a shaft 34 activating fan blades 36 therebehind and driving a fan cover 38, which is arranged in front of the ribs for adjusting wind directions. The circular casing 22 gradually tapered from an exterior portion to an interior portion for guiding airs fluently.

The photocatalyst lighting device 40 includes a lamp 42 annularly exposed out the ribs 24, a photocatalyst sleeve 44 having a Titanium Dioxide (TiO2) coating and wrapping on the lamp 42, a driving module 46 electrically connecting the lamp 42, and a lampshade 50 annularly arranged on an exterior peripheral of the lamp 42. Further, the photocatalyst sleeve 44 can be made of a fiber-glass material, the driving module 46 includes stabilization device and a switch to drive the lamp 42 (structures of the driving module 46 should be obvious for a skillful person in the art), and electrically connects an electrical connector 422 of the lamp 42, the driving module 46 connects the ribs 24.

Further, the fan device 20 includes resilient clamping members 28 disposed on the ribs 24 for engaging the lamp 42 between the resilient clamping members 28 (see FIG. 2A), or the fan device 20 includes a recess 26 formed on the ribs 24 for engaging the lamp 42 therein. The lampshade 50 has a plurality of through holes 52 arranged thereon for passing the airs, and the lampshade 50 engages with a front flange of the circular casing 22 and further supporting the lamp 42. In addition, if the air cleaner 1 is used in a darkroom for developing films or others the like, the lampshade 50 can be made of dark-colored materials or opaque materials.

The air cleaner 1 further includes a circular diversion sheet 60 arranged between the fan cover 38 and the lamp 42, the circular diversion sheet 60 is oriented on the ribs 24 and extends from an inner portion to an outer portion for guiding airs to lamp 42 fluently and efficiently.

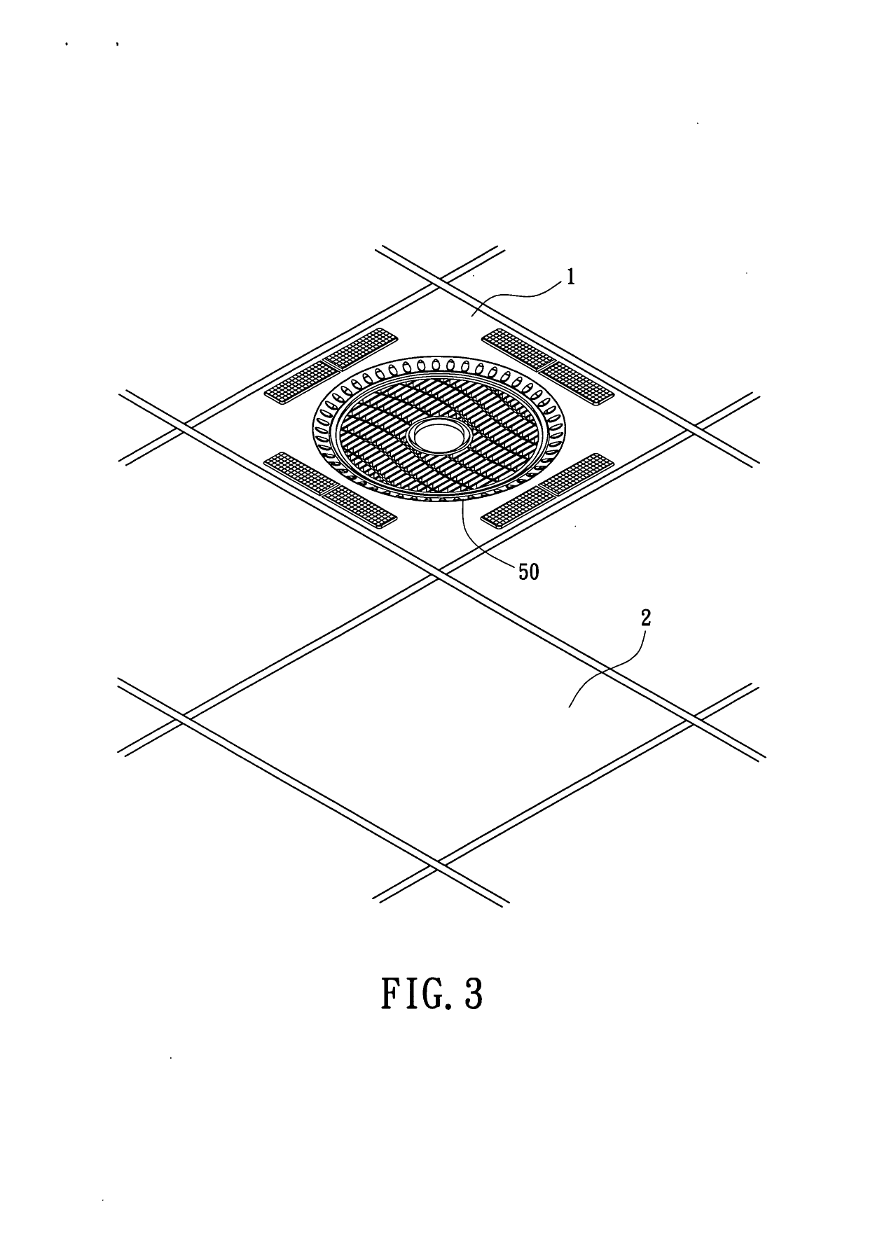

With respect to FIG. 3, the air cleaner 1 can be disposed on a suspension ceiling 2 easily. The photocatalyst lighting device provides not only sterilization, but also the indoors lighting. The lamp 42 can be replaced by removing the lampshade 50 while wearing out. A circular receiving space between the circular diversion sheet 60 and the circular casing 22 can be used for receiving and protecting the lamp 42. The lamp 42 remotes from the fan blades 36 and the fan cover 38 to connect in the circular receiving space to prevent loosing therefrom or breaking by the fan blades 36 or the fan cover 38.

The present invention provides characters of:

The lamp 42 is annularly arranged surround the fan cover 38 for increasing an irradiate surface area of the photocatalyst sleeve 44.

The air cleaner 1 is cheaper and safer than the suspension ozone air cleaner according to the second prior art.

The lamp 42 can provide lighting while assembling on the suspension ceiling to improve a luminance thereof.

The present invention occupies no vacancy on floors and can be equipped in an office, a factory, a school, a hospital or a house.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

1. An air cleaner with photocatalyst materials adopted for a light-gauge steel frame, comprising:
a housing including a faceplate, a cover arranged behind the faceplate, and a receiving cavity formed between the faceplate and the cover, the faceplate having an exhaust and a plurality of air filer frames with filters;
a fan device including a circular casing oriented in the receiving cavity, a plurality of ribs disposed in the circular casing, an air supply device disposed on the ribs, and a fan cover arranged in front of the ribs for adjusting wind directions;
a photocatalyst lighting device including a lamp annularly exposed out the fan cover and disposed adjacent to exterior ends of the ribs, a photocatalyst sleeve having a Titanium Dioxide (TiO₂) coating and wrapping on the lamp, and a driving module electrically connecting the lamp; and
a lampshade annularly arranged on an exterior peripheral of the lamp.

2. The air cleaner claimed as claim 1, wherein the lampshade has a plurality of through holes arranged thereon.

3. The air cleaner claimed as claim 1, wherein the lampshade engages with a front flange of the circular casing and supporting the lamp.

4. The air cleaner claimed as claim 1, wherein the cover has a flat bottom plate separated from the circular casing with a predetermined distance.

5. The air cleaner claimed as claim 1, wherein the cover has a plurality of oblique plates respectively arranged on sides thereof for guiding airs fluently.

6. The air cleaner claimed as claim 1, wherein the circular casing gradually tapered from an exterior portion to an interior portion for guiding airs fluently.

7. The air cleaner claimed as claim 1, further including a circular diversion sheet arranged between the fan cover and the lamp, the circular diversion sheet oriented on the ribs and extending from an inner portion to an outer portion for guiding airs to lamp fluently and efficiently.

8. The air cleaner claimed as claim 1, wherein the fan device includes a recess formed on the ribs for engaging the lamp therein.

9. The air cleaner claimed as claim 1, wherein the fan device includes resilient clamping members disposed on the ribs for engaging the lamp between the resilient clamping members.

10. The air cleaner claimed as claim 1, wherein the air filer frames is adjacent to the exhaust, and the filters are replaceable.

11. The air cleaner claimed as claim 1, wherein the circular casing connects the exhaust of the faceplate.

12. The air cleaner claimed as claim 1, wherein the air supply device has a motor oriented on a middle of the ribs, the motor has a shaft activating fan blades therebehind and driving the fan cover.
